(19) United States
(12) Patent Application Publication
(10) Pub. No.: US 2009/0087516 A1
(43) Pub. Date: Apr. 2, 2009

(54) Dried meat product and method for making same

(76) Inventors: Mark Tilsen, Rapid City, SD (US); Duane Lammers, Hermosa, SD (US)

Correspondence Address: PATTON BOGGS, LLP, 2001 ROSS AVENUE, SUITE 3000, DALLAS, TX, 75201, US

(21) Appl. No.: 11/906,224

(22) Filed: Oct. 1, 2007

(51) Int. Cl. A23L 1/314

(52) U.S. Cl. 426/56

(57) ABSTRACT

The present dried meat products and method for making dried meat products (dried meat product) does not add any preservative compounds containing nitrates and nitrites to preserve the meat product. The present dried meat product includes a meat tissue that is mixed with a marinade that contain cranberries, starter culture, and vegetable juice, in addition to other ingredients without the addition of nitrate or nitrite specific containing compounds. The marinated meat tissue is then fermented, dried, smoked, and preferably dried again. This process provides natural preservatives without the addition of nitrate or nitrite containing preservative compounds.

### FIELD OF THE INVENTION

The present invention relates to dried meat products and method for making dried meat products without adding compounds containing nitrates, nitrites, or both as preservatives.

### DESCRIPTION OF BACKGROUND INFORMATION

Studies have shown that meat products generally contain high amounts of saturated fat and cholesterol, both which can lead to the cause of heart disease. Nevertheless, meat is a good source of many required nutrients, such as iron and protein. Cooking processes, like drying, reduce the amount of fat contained in meat while adding flavor to the meat.

Food preservatives are commonly used in dried meats to preserve the reddish pink color of the meat and to prevent the growth of some bacteria. Common salt was used for decades to preserve dried meat, which was followed by the use of sodium nitrate (NaNO₃) when it was found to be a component of most common salts and the primary source of the beneficial effects. Later, it was found that nitrates are converted to nitrites by bacterial action, thus more recently sodium nitrite (NaNO₂) has been the preferential additive. Nevertheless, some scientific studies have raised health questions of nitrites in our food sources and diets. In fact, the USDA has issued a report noting fatal dosages for humans of sodium nitrate and sodium nitrite. Nevertheless, the current conventional methods and processes for drying meats continue to add compounds containing nitrates and nitrites to their meat products as preservatives during their processes.

### SUMMARY OF THE INVENTION

The above-described problems are solved and a technical advance achieved by the present dried meat products and method for making dried meat products (dried meat product) that does not add any compounds containing nitrates and nitrites to preserve the meat product. The present dried meat product includes a meat tissue that is mixed with a marinade that contain cranberries, starter culture, and vegetable juice, in addition to other ingredients without the addition of nitrate or nitrite specific containing compounds. The marinated meat tissue is then fermented, dried, smoked, and preferably dried again. This process provides natural preservatives without the addition of nitrate or nitrite containing preservative compounds.

### BRIEF DESCRIPTION OF THE DRAWINGS

FIG. 1 illustrates an exemplary mixing apparatus according to an embodiment of the present invention;

FIG. 2 illustrates an exemplary drying apparatus according to an embodiment of the present invention; and

FIG. 3 illustrates a block flow diagram for a method for making dried meats according to an embodiment of the present invention.

### DETAILED DESCRIPTION OF THE DRAWINGS

The present dried meat product includes a meat tissue that is mixed with a marinade mixture and then dried in a fermenting, drying, and smoking process to produce a dried meat product without adding compounds of nitrates and nitrites to the dried meat, as is found with conventional operations.

In one embodiment, the meat tissue may be selected bison, beef, buffalo, pork poultry, and lamb. In addition, other animal sources may be used for the source of the meat tissue. If the meat tissue is frozen, then preferably it should be thawed prior to mixing with the marinade mixture described below. The meat tissue may be reduced in size to pieces or strands having an overall general size of between about 1/16″ to about 2″. The meat tissue may be cut using any type of cutting utensils, such as knifes and the like or may be reduced in size by a grinder. In one aspect, the grinder may have a grinder plate of suitable size for grinding the meat tissue to a desired size. For example, the meat tissue may be reduced to pieces or strands each having a general overall size or diameter of approximately 3/16″.

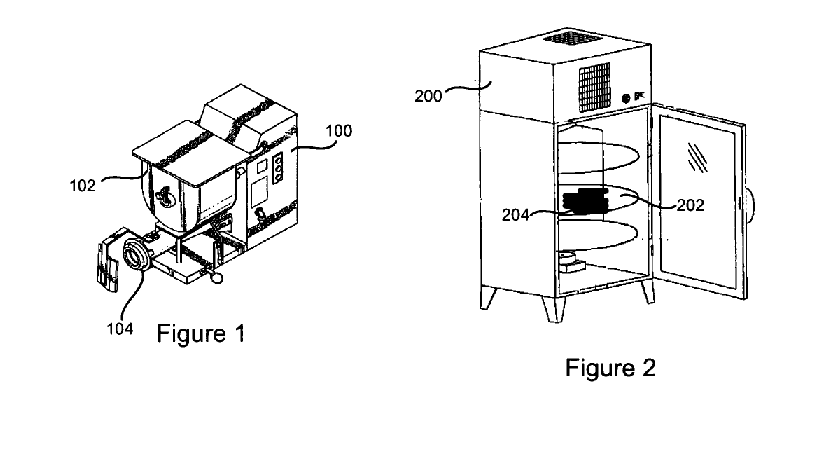

In one embodiment, the marinade mixture is prepared from the following ingredients: cranberries, starter culture, and vegetable juice. In addition, the marinade mixture may include salt, soy sauce, Worcestershire® sauce, white pepper, black pepper, and garlic powder. These ingredients are mixed in proportions and preferably in the order described herein in a mixing vessel, such as mixer 100 (FIG. 1), bowls, hand turn mixers, electric meat mixers, and the like. Preferably, mixer 100 includes a mixing vessel 102 for mixing the ingredients and the meat tissue prior to drying it as described below. Preferably, these ingredients, excluding the cranberries, are combined in the mixing vessel 102 and mixed to a desired consistency before the cranberries are added to the mixing vessel 102. Mixer 100 may also include a grinder 104 or this may be a separate unit as known to those skilled in the art. In addition, attachments, such as a stuffing horn (not shown), may be attached to the end of the grinder 104 for shaping the meat tissue prior to drying process described below.

In another embodiment, the marinade mixture is prepared from the following ingredients: cranberries, starter culture, and vegetable juice. In addition, the marinade mixture may include salt, Allspice, white pepper, black pepper, and garlic powder. These ingredients are mixed in proportions and preferably in the order described herein in a mixing vessel, such as mixer 100 (FIG. 1), bowls, hand turn mixers, electric meat mixers, and the like. Preferably, mixer 100 includes a mixing vessel 102 for mixing the ingredients and the meat tissue prior to drying it as described below. Preferably, these ingredients, excluding the cranberries, are combined in the mixing vessel 102 and mixed to a desired consistency before the cranberries are added to the mixing vessel 102. Mixer 100 may also include a grinder 104 or this may be a separate unit as known to those skilled in the art. In addition, attachments, such as a stuffing horn (not shown), may be attached to the end of the grinder 104 for shaping the meat tissue prior to drying process described below.

The starter culture may be dissolved with water, such as distilled water, prior to mixing in the mixing vessel 102. The starter culture may be any type of starter culture including Bactoferm™ starter culture. Preferably, the starter culture is present in an amount from about 0.6 grams (gms) to about 2.5 gms per approximately 10 pounds (4540 gms) of meat tissue. Any weight units may be used that are consistent with the ratios and amounts expressed herein, thus a more generic expression of units used herein may be parts by weight (PB %. More preferably, the starter culture is present in the amount of approximately 15.3 gms per 4540 gms of meat tissue.

The vegetable juice is preferably present in the form of a powder, but may be in other forms, such as a liquid or freeze dried as well. In one aspect, the vegetable juice powder is celery powder and is present in an amount from about 7.6 gms to about 30.6 gms per approximately 4540 gms of meat tissue. More preferably, the celery powder is present in the amount of approximately 1.25 gms per approximately 4540 gms of meat tissue. Other vegetable juice powders may be used as well, including beet and celery juice powders.

Many different types of salt may be used, including table salt, iodized salt, sea salt, kosher salt, and the like. The salt is preferably present in an amount from about from about 70 gms to about 280 gms per approximately 4540 gms of meat tissue. More preferably, the salt is present in the amount of approximately 140.6 gms per approximately 4540 gms of meat tissue. The soy sauce is preferably present in the amount from about from about 28 gms to about 113 gms per approximately 4540 gms of meat tissue. More preferably, the soy sauce is present in the amount of approximately 56.8 gms per approximately 4540 gms of meat tissue.

The Worcestershire® sauce or Worcestershire-type sauce is present in the amount of from about 5.7 gms to about 23 gms per approximately 4540 gms of meat tissue. More preferably, the Worcestershire® sauce is present in the amount of approximately 11.4 gms per approximately 4540 gms of meat tissue. Each of the white pepper and black pepper is present in the amount of from about 3 gms to about 12 gms per approximately 4540 gms of meat tissue. More preferably, each is present in the amount of approximately 6 gms per approximately 4540 gms of meat tissue. Finally, the garlic powder is present in the amount of from about 1.5 gms to about 6 gms per approximately 4540 gms of meat tissue. More preferably, the garlic powder is present in the amount of approximately 3 gms per approximately 4540 gms of meat tissue. In another embodiment, the Worcestershire-type sauce and soy sauce are replaced by Allspice. In this embodiment, amounts of Allspice are used equal to the amounts of the combined Worcestershire-type sauce and soy sauce.

The cranberries may be fresh, frozen, or dried cranberries and are present in the amount of from about 680 gms to about 2700 gms per approximately 4540 gms of meat tissue. More preferably, the cranberries are present in the amount of approximately 1362 gms per approximately 4540 gms of meat tissue. In one aspect, the cranberries are reduced in size to pieces having an overall general size of preferably between about 1/16″ to about 1″. The cranberries may be reduced in size using any type of cutting utensils, such as knifes and the like or may be reduced in size by a grinder 104. In one aspect, the grinder 104 may have a grinder plate (not shown) of suitable size for grinding the meat tissue to a desired size. In one aspect, the meat tissue is reduced to pieces or strands each having a general overall size or diameter of approximately 3/16″. In yet another aspect, a portion of the meat tissue is ground with the cranberries to prevent the cranberries from sticking together when mixing.

As disclosed above, the ingredients amounts are each present per approximately 4540 gms of meat tissue. These ingredient amounts may be increased or decreased depending on the batch size to be made. For example, if 30 pounds of meat tissue is used, then the amounts above would be approximately tripled.

As disclosed above, the ground meat tissue and ingredients, excluding the cranberries, are mixed together in the mixing vessel 102 for a period of time to produce a consistent meat mixture, typically for approximately 5 minutes. This ensures reasonable protein extraction and visible stickiness prior to the addition of the cranberries. Other mixing times may be employed as well. Once a desired consistency is achieved, then the cranberries are added to the mixing vessel 102 and the entire mixture is mixed to produce a marinated meat tissue having a desirable consistency.

The following drying process is then applied to the marinated meat mixture. The mixture is preferably fermented for approximately 10 minutes to about 4 hours, and more preferably 2 hours in an approximately 80% relative humidity, 105° F. dry bulb and 95° F. wet bulb, environment. The fermenting, drying, and smoking steps below may occur in any type of apparatus used by those skilled in the art for drying meat tissues. Referring to FIG. 2, one exemplary device is a meat cooker 200, such as a smoker, having a plurality of racks 202 on which the marinated meat tissue 204 is placed. In one aspect, a smokehouse performs the fermentation and cooking steps.

The marinated meat tissue 204 is then preferably dried a first time from about 30 minutes to about 2 hours at a temperature from about 140° F. to about 200° F. in an environment with approximately 45% relative humidity environment, 140° F. wet bulb temperature. More preferably, the marinated meat tissue 204 is dried a first time for approximately 1 hour at approximately 170° F. in an environment with approximately 45% relative humidity.

Then the marinated meat tissue 204 is then preferably smoked for from about 30 minutes to about 4 hours at a temperature from about 100° F. to about 160° F. More preferably, the marinated meat tissue 204 is smoked for 2 hours at approximately 130° F.

The marinated meat tissue 204 is then preferably dried a second time from about 90 minutes to about 9 hours at a temperature from about 140° F. to about 200° F. More preferably, the marinated meat tissue 204 is dried a second time for approximately 3 hours at approximately 170° F. The marinated meat tissue 204 is then preferably dried a third time from about 30 minutes to about 2 hours at a temperature from about 100° F. to about 160° F. More preferably, the marinated meat tissue 204 is dried a third time for approximately 1 hour at approximately 130° F.

The above process produces a dried meat product with no added nitrate or nitrite containing preservative compounds, unlike conventional processes. This dried meat product is then cooled and packaged as desired, including gas flushing its package with an inert gas, such as nitrogen or argon.

One exemplary formulation of marinade mixtures is given below in Tables 1. All amounts are represented by gms.

TABLE 1

Examples

| | 1 | 2 |
|---|---|---|
| Meat Tissue (Bison) | 4540 | 13620 |
| Salt | 140.6 | 421.8 |
| Natural Soy Sauce | 56.8 | 170.4 |
| Worcestershire ® Sauce | 11.4 | 34.2 |
| White Pepper | 6 | 18 |
| Black Pepper | 6 | 18 |
| Garlic Powder | 3 | 9 |
| Sweetened Dried Cranberries | 1362 | 4086 |
| Bactoferm Starter Culture | 1.25 | 3.75 |
| Vegetable Juice (Celery) | 15.3 | 45.9 |
| Powder | | |

Another exemplary formulation of marinade mixtures is given below in Table 2. All amounts are represented by gms.

TABLE 2

Examples

| | 1 | 2 |
|---|---|---|
| Meat Tissue (Bison) | 4540 | 13620 |
| Salt | 140.6 | 421.8 |
| Allspice | 68.2 | 204.6 |
| White Pepper | 6 | 18 |
| Black Pepper | 6 | 18 |
| Garlic Powder | 3 | 9 |
| Sweetened Dried Cranberries | 1362 | 4086 |
| Bactoferm Starter Culture | 1.25 | 3.75 |
| Vegetable Juice (Celery) | 15.3 | 45.9 |
| Powder | | |

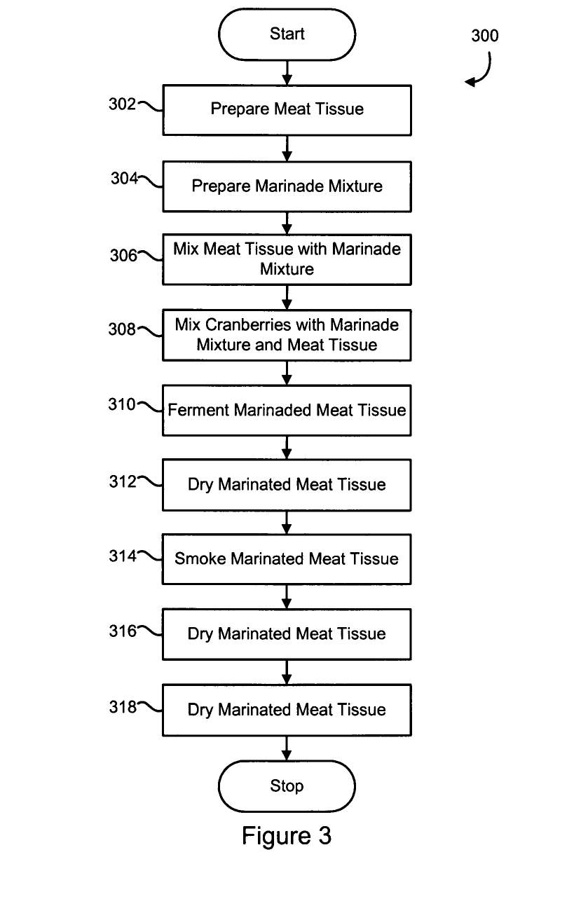

In one embodiment, the present dried meat product includes a method for making dried meat products. FIG. 3 illustrates a block flow diagram of an embodiment 300 of a method for making a dried meat product. In step 302, a meat tissue is prepared to a desirable state and size. If the meat tissue is frozen, then it should be thawed prior to mixing with the marinade ingredients. Further, the meat tissue should be cut or ground to a desirable size. If the meat tissue In step 304, the marinade mixture is prepared in a mixing vessel. This step includes mixing salt, natural soy sauce, Worcestershire® sauce, white pepper, black pepper, garlic powder, celery powder, and starter culture. In this step, the starter culture is preferably mixed with a small amount of distilled water. In step 306, the prepared meat tissue is added to the mixture in the mixing vessel and mixed for approximately 5 minutes.

In step 308, cranberries prepared as described herein are added to the marinade mixture. The meat tissue and marinade mixture are mixed for approximately 5 minutes, or until uniform consistency. In step 310, the marinated meat tissue 204 is fermented for approximately 2 hours at 105° F. Then, in step 312, the marinated meat tissue 204 is dried for approximately 1 hour at 170° F. in an environment of 45% relative humidity, 140° F. wet bulb temperature. In step 314, the marinated meat tissue 204 is smoked for 2 hours at 130° F. This is followed in step 316 by a second drying for 3 hours at 170° F. Then, in step 318, the marinated meat tissue 204 is dried a third time for 1 hour at 130° F.

There has been described a dried meat product and method for making same. It should be understood that the particular embodiments described within this specification are for purposes of example and should not be construed to limit the invention. Further, it is evident that those skilled in the art may now make numerous uses and modifications of the specific embodiment described, without departing from the inventive concepts. For example, different ranges of ingredients and ingredient types may be used without departing from the inventive concepts.

What is claimed:

1. A method for making a dried meat product comprising:
providing a meat tissue;
providing a marinade mixture comprising cranberries, starter culture, and vegetable juice;
mixing said meat tissue with said marinade mixture; and
drying said meat tissue to produce said dried meat product.

2. The method for making a dried meat product of claim 1 wherein said meat tissue is selected from the group consisting of bison, beef, buffalo, pork poultry, and lamb.

3. The method for making a dried meat product of claim 1 wherein said providing a meat tissue further comprises:
grinding said meat tissue to produce said meat tissue having a size of from about 1/16″ to about 2″.

4. The method for making a dried meat product of claim 1 wherein said mixing further comprises:
mixing said meat tissue with said starter culture and vegetable juice prior to mixing said meat tissue with said cranberries.

5. The method for making a dried meat product of claim 4 wherein said mixing said meat tissue with said starter culture and vegetable juice is for at least 2 minutes prior to mixing said meat tissue with said cranberries.

6. The method for making a dried meat product of claim 1 wherein said providing a marinade mixture further comprises:
grinding said cranberries to produce said cranberries having a size of from about 1/16″ to about 1″.

7. The method for making a dried meat product of claim 6 wherein said grinding said cranberries comprises:
grinding a portion of said meat tissue with said cranberries.

8. The method for making a dried meat product of claim 1 further comprising:
stuffing under vacuum said meat tissue through a stuffing horn.

9. The method for making a dried meat product of claim 8 further comprising:
placing said stuffed meat tissue on a jerky rack.

10. The method for making a dried meat product of claim 1 wherein said drying comprises:
fermenting said meat tissue in an atmosphere having from about 20 percent to about 100 percent relative humidity.

11. The method for making a dried meat product of claim 10 wherein said fermenting is from about 10 minutes to about 4 hours.

12. The method for making a dried meat product of claim 1 wherein said drying comprises:
drying said meat tissue a first time at a temperature from about 140° F. to about 200° F.

13. The method for making a dried meat product of claim 12 further comprising:
drying said meat tissue for said first time from about 30 minutes to about 120 minutes.

14. The method for making a dried meat product of claim 1 wherein said drying further comprises:
smoking said meat tissue at a temperature from about 100° F. to about 160° F.

15. The method for making a dried meat product of claim 14 wherein said drying further comprises:
smoking said meat tissue for a time from about 30 minutes to about 240 minutes.

16. The method for making a dried meat product of claim 1 wherein said drying comprises:
drying said meat tissue a second time at a temperature from about 140° F. to about 200° F.

17. The method for making a dried meat product of claim 16 further comprising:
drying said meat tissue for said second time from about 90 minutes to about 540 minutes.

18. The method for making a dried meat product of claim 1 further comprising:
drying said meat tissue a third time at a temperature from about 100° F. to about 160° F.

19. The method for making a dried meat product of claim 18 further comprising:
drying said meat tissue for said third time from about 30 minutes to about 120 minutes.

20. The method for making a dried meat of claim 1 further comprising:
cooling said dried meat product; and
packaging said dried meat product.

21. A composition for marinating a meat tissue to be dried comprising:
cranberries, starter culture, and vegetable juice.

22. The composition for marinating a meat tissue to be dried of claim 21 further comprising at least one component selected from the group consisting of salt, soy sauce, Worcestershire® sauce, white pepper, black pepper, and garlic powder.

23. The composition for marinating a meat tissue to be dried of claim 21 wherein said cranberries are dried cranberries.

24. The composition for marinating a meat tissue to be dried of claim 21 wherein said cranberries are present from about 680 PBW to about 2700 PBW.

25. The composition for marinating a meat tissue to be dried of claim 21 wherein said vegetable juice is in powder form.

26. The composition for marinating a meat tissue to be dried of claim 21 wherein said vegetable juice is present from about 7.6 PBW to about 30.6 PBW.

27. The composition for marinating a meat tissue to be dried of claim 21 wherein said starter culture is present from about 0.6 PBW to about 2.5 PBW.

28. The composition for marinating a meat tissue to be dried of claim 22 wherein said garlic powder is present from about 1.5 PBW to about 6 PBW.

29. The composition for marinating a meat tissue to be dried of claim 22 wherein said black pepper and said white pepper is present from about 3 PBW to about 12 PBW.

30. The composition for marinating a meat tissue to be dried of claim 22 wherein said Worcestershire® sauce is present from about 5.7 PBW to about 23 PBW.

31. The composition for marinating a meat tissue to be dried of claim 22 wherein said soy sauce is present from about 28 PBW to about 113 PBW.

32. The composition for marinating a meat tissue to be dried of claim 22 wherein said salt is present from about 70 PBW to about 280 PBW.

33. The composition for marinating a meat tissue to be dried of claim 21 wherein said meat tissue is present from about 2200 PBW to about 9100 PBW.

34. A method for making a dried meat product comprising:
combining starter culture, vegetable juice powder, salt, soy sauce, Worcestershire® sauce, white pepper, black pepper, and garlic powder into a mixing vessel to produce a mixture;
mixing a meat tissue with said mixture in said mixing vessel to produce a meat mixture;
mixing cranberries with said meat mixture in said mixing vessel to produce a marinated meat tissue;
stuffing said marinated meat tissue under a vacuum; and
drying said marinated meat tissue to produce said dried meat product.

35. The method for making a dried meat product of claim 34 further comprising:
grinding said meat tissue to produce said meat tissue having a size of from about 1/16″ to about 2″.

36. The method for making a dried meat product of claim 34 further comprising:
grinding a portion of said meat tissue with said cranberries prior to mixing said cranberries with said meat mixture.

37. The method for making a dried meat product of claim 34 further comprising:
fermenting said meat tissue in an atmosphere having from about 20 percent to about 100 percent relative humidity.

38. The method for making a dried meat product of claim 34 wherein said drying comprises:
drying said meat tissue a first time at a temperature from about 140° F. to about 200° F.

39. The method for making a dried meat product of claim 38 further comprising:
drying said meat tissue for said first time from about 30 minutes to about 120 minutes.

40. The method for making a dried meat product of claim 34 wherein said drying further comprises:
smoking said meat tissue at a temperature from about 100° F. to about 160° F.

41. The method for making a dried meat product of claim 40 wherein said drying further comprises:
smoking said meat tissue for a time from about 30 minutes to about 240 minutes.

42. The method for making a dried meat product of claim 34 wherein said drying comprises:
drying said meat tissue a second time at a temperature from about 140° F. to about 200° F.

43. The method for making a dried meat product of claim 42 further comprising:
drying said meat tissue for said second time from about 90 minutes to about 540 minutes.

44. The method for making a dried meat product of claim 34 further comprising:
drying said meat tissue a third time at a temperature from about 100° F. to about 160° F.

45. The method for making a dried meat product of claim 44 further comprising:
drying said meat tissue for said third time from about 30 minutes to about 120 minutes.
